(19) United States
(12) Patent Application Publication
(10) Pub. No.: US 2017/0261385 A1
(43) Pub. Date: Sep. 14, 2017

(54) THERMOMETER FOR A GRILL

(71) Applicant: Transworld Imports, Inc., Suwanee, GA (US)

(72) Inventor: Ashish Kohli, Atlanta, GA (US)

(21) Appl. No.: 15/293,695

(22) Filed: Oct. 14, 2016

Related U.S. Application Data
(60) Provisional application No. 62/306,782, filed on Mar. 11, 2016.

(51) Int. Cl. G01K 13/00; A47J 37/07; G01K 1/04

(52) U.S. Cl. CPC G01K 13/00; G01K 1/04; A47J 37/0786

(57) ABSTRACT

A thermometer for a grill, including a body portion having a display panel disposed on a front side of the body portion, a graduated temperature scale disposed on the display panel, the temperature scale indicating a range of temperatures from a low temperature to a high temperature, an indicator needle that is pivotable with respect to the body portion so as to pivotably move relative to the temperature scale, thereby indicating an internal temperature of the grill, a first display portion that extends from a first temperature to a second temperature on the temperature scale, thereby defining a first temperature range therebetween, the first display portion being a first color, and a sensor probe extending outwardly from a back side of the body portion, wherein the body portion is disposed on an outer surface of the grill and the sensor probe extends into an interior of the grill.

### CLAIMS OF PRIORITY

This application claims priority to U.S. Provisional Application Ser. No. 62/306,782, filed Mar. 11, 2016, the entire disclosure of which is incorporated by reference herein.

### FIELD OF THE INVENTION

The present invention relates generally to grills and smokers. More particularly, the present invention relates to a thermometer for use with an outdoor grill or smoker.

### BACKGROUND OF THE INVENTION

The popularity of Kamado style grills has increased greatly in recent years. The thick ceramic walls of these grills improve temperature control and the retention of heat within the grill. As such, a typical user is able to perform many types of food preparation with a grill that have traditionally not been effective with standard metal bodied grills. For example, the improved temperature control afforded by Kamado grills makes it much easier to maintain temperature within a desired range to smoke meats for hours, bake food items at the proper temperature, etc.

Of course, it is known to use a thermometer to monitor the internal temperature of a grill. A typical thermometer will include a display portion that is mounted to the housing of the grill and a probe extending therefrom into the interior of the grill. An expected range of operating temperatures is provided on the display, as well as a needle that indicates the temperature on that range that corresponds to the interior temperature of the grill. The large temperature ranges over which Kamado style grills operate often means that the graduated scale provided on the thermometer's display is smaller than is desirable to facilitate reading the grill's temperature. As well, smoking operations often take hours to complete, with it only being necessary to maintain the grill's temperature within a desired range, rather than at a specific temperature. As such, it is desirable for a user to be able to determine the approximate temperature of the grill more easily, without the user having to be directly by the grill.

The present invention recognizes and addresses considerations of prior art constructions and methods.

### SUMMARY OF THE INVENTION

One embodiment of the present disclosure provides a thermometer for a grill, including a body portion having a display panel disposed on a front side of the body portion, a graduated temperature scale disposed on the display panel, the temperature scale indicating a range of temperatures from a low temperature to a high temperature, an indicator needle that is pivotable with respect to the body portion so as to pivotably move relative to the temperature scale, thereby indicating an internal temperature of the grill, a first display portion that extends from a first temperature to a second temperature on the temperature scale, thereby defining a first temperature range therebetween, the first display portion being a first color, and a sensor probe extending outwardly from a back side of the body portion, wherein the body portion is disposed on an outer surface of the grill and the sensor probe extends into an interior of the grill.

Another embodiment of the present disclosure provides a thermometer for a grill, including a body portion having a display panel disposed on a front side of the body portion, a graduated temperature scale disposed on the display panel, the temperature scale indicating a range of temperatures from a low temperature to a high temperature, an indicator needle that is pivotable with respect to the body portion so as to pivotably move relative to the temperature scale, thereby indicating an internal temperature of the grill, and a food-type designator including a marker disposed on a specific temperature of the temperature scale and a word description of a corresponding food item, wherein the specific temperature corresponds to an internal temperature of the grill for preparing the corresponding food item, a sensor probe extending outwardly from a back side of the body portion, wherein the body portion is disposed on an outer surface of the grill and the sensor probe extends into an interior of the grill.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is a front view of a grill/smoker including a thermometer in accordance with an embodiment of the present disclosure;

FIG. 2 is a perspective view of the thermometer shown in FIG. 1;

FIG. 3 is a front view of a display panel of the thermometer shown in FIG. 1;

FIG. 4 is a front view of an alternate embodiment of a thermometer in accordance with the present disclosure; and

FIG. 5 is a front view of an alternate embodiment of a thermometer in accordance with the present disclosure.

Repeat use of reference characters in the present specification and drawings is intended to represent same or analogous features or elements of the invention according to the disclosure.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

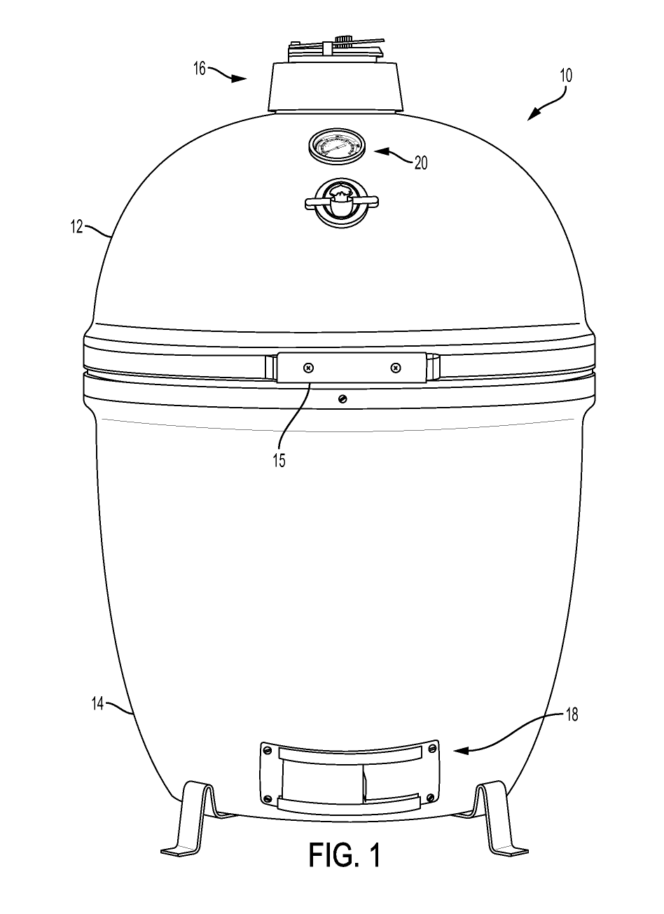

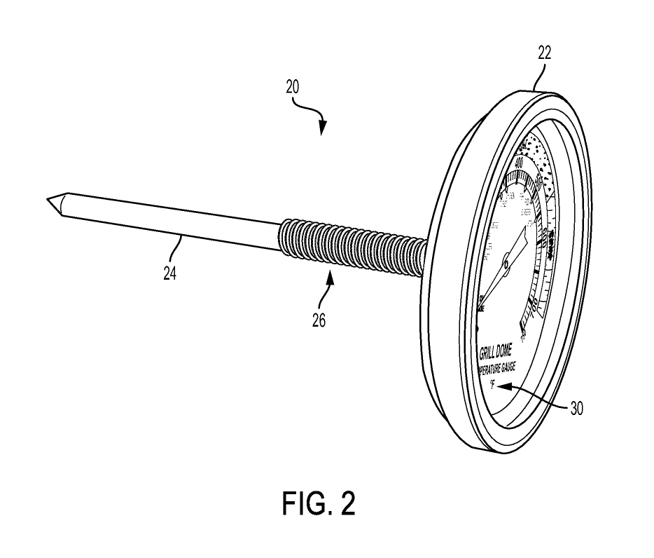

Referring now to the FIGS. 1 and 2, an embodiment of a thermometer 20 in accordance with the present invention is shown mounted on a grill 10. Preferably, grill 10 is a Kamado-style grill and includes a top housing portion 12 and a bottom housing portion 14 that both include thick ceramic walls. Note, however, thermometer 20 may be used with all types of grills, smokers, etc. A first damper 16 and a second damper 18 are provided on top housing portion 12 and bottom housing portion 14 of grill 10, respectively, to control air flow through the interior of the grill, thereby allowing the interior temperature to be adjusted. Top housing portion 12 is pivotably connected to bottom housing portion 14 by a hinge (not shown), and a handle 15 is provided so that top housing portion 12 may be opened and closed.

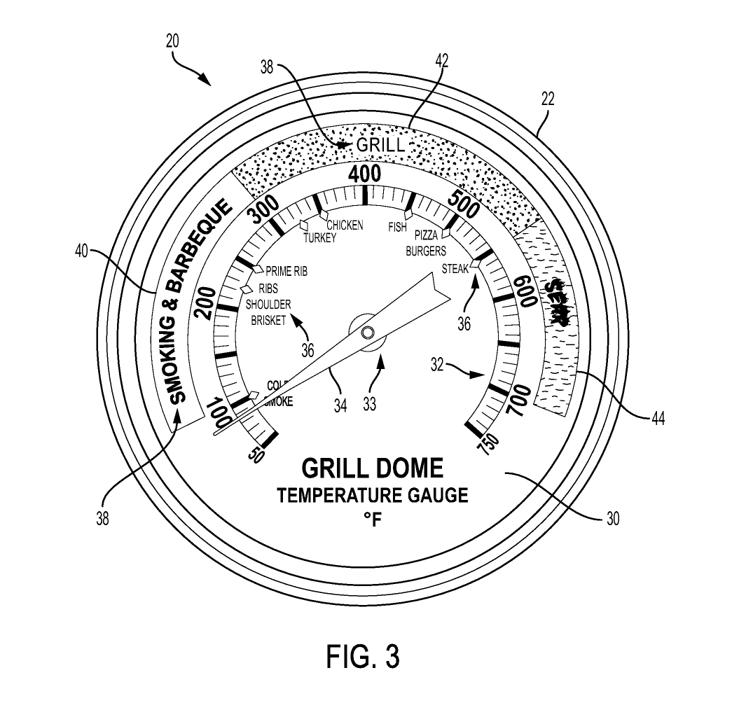

Referring additionally to FIG. 3, thermometer 20 includes a disc-shaped body portion 22 including a display panel 30 and a sensor probe 24 extending outwardly from the back of body portion 22. Sensor probe 24 includes a threaded portion 26 that is adjacent body portion 22 of the thermometer. Threaded portion 26 is used to removably secure thermometer 10 to top housing portion 12, which includes a correspondingly threaded bore therein (not shown). Note, however, in alternate embodiments, the bore formed in top housing portion 12 can be a smooth bore and a threaded fastener, such as a nut, may be used to engage threaded portion 26, thereby securing the thermometer to top housing portion 12. As well, in yet other embodiments, a spring clip, or like device, may be used to secure the thermometer to grill 10, and threaded portion 26 may be omitted from sensor probe 24. When secured to top housing portion 12 of the grill, sensor probe 24 extends inwardly into the interior of grill 10, thereby allowing the detection of the grill's interior temperature.

As best seen in FIG. 3, display panel 30 includes a graduated temperature scale 32 disposed thereon. Temperature scale 32 indicates an expected range of operating temperatures for grill 10 that extends from a low temperature, in the present case 50°, to a high temperature, in the instant case 750°. As shown, temperature scale 32 is semi-circular in shape, corresponding to the circular shape of display panel 30. Note, in alternate embodiments, both the display panel 30 and the temperature scale 32 need not be semi-circular. An indicator needle 34 is pivotably attached to the center of body portion 22, which corresponds to the center 33 of display panel 30. As is known in the art, indicator needle 34 pivots relative to display panel 30 dependent upon the internal temperature of grill 10. As indicator needle 34 pivots in response to changing temperatures within the grill, its distal end moves along temperature scale 32, thereby indicating the interior temperature of the grill.

Still referring to FIG. 3, display panel includes first, second, and third display portions 40, 42, and 44, respectively. Each display portion is indicative of a method of preparing food, and defines a temperature range between a first temperature and a second temperature, over which that cooking method is properly performed. For example, first display portion 40 extends from a first temperature of 100° to a second temperature of 300°, thereby defining a desirable temperature range of internal grill temperatures over which the food preparation method of smoking and barbequing is performed. Preferably, each display portion has a color that differs from the colors selected for the other display portions, and a word description 38 of the method of food preparation that is represented by the display portion. For example, in the preferred embodiment shown, first display portion 40 is yellow in color and includes the word designation 38 of “smoking and barbeque”. In the embodiment shown, second display portion 42 extends from a first temperature of 300° to a second temperature of 550°, thereby defining a temperature range over which the food preparation method of grilling, as indicated by word designator 38, occurs. Preferably, the color of second display portion 42 is orange. The third display portion 44 extends from a first temperature of 550° to a second temperature of 700°, thereby defining a temperature range over which the food preparation method of searing occurs, as indicated by word designator 38. In the preferred embodiment shown, the color selected for third display portion 44 is red. Preferably, first, second, and third display portions 40, 42, and 44, are disposed radially-outwardly of temperature scale 32, and are semi-circular in shape (i.e., each forms an arch). Note, in alternate embodiments, fewer or more display portions may be shown on display panel 30, and the ranges of temperatures they represent need not be the same as those shown, as these are merely portions of an exemplary embodiment.

In addition to providing display portions representative of temperature ranges for popular methods of food preparation, display panel 30 also includes food-type designators 36 that include a marker disposed on a specific temperature of temperature scale 32 at which a type of food is ideally prepared. As well, each food-type designator 36 includes a word description of the food to be prepared at a specific temperature. For example, as shown in FIG. 3, one food-type designator 36 indicates that when preparing pizza and/or burgers, a desirable internal temperature of gill 10 is 500°, whereas a second food-type designator 36 indicates that for the preparation of prime rib, a desirable internal temperature of grill 10 is 250°. Note, these specific temperatures and food types shown in FIG. 3 are merely representative of the preferred embodiment, and may be changed to represent differing food types other than those shown and different internal temperatures for the grill.

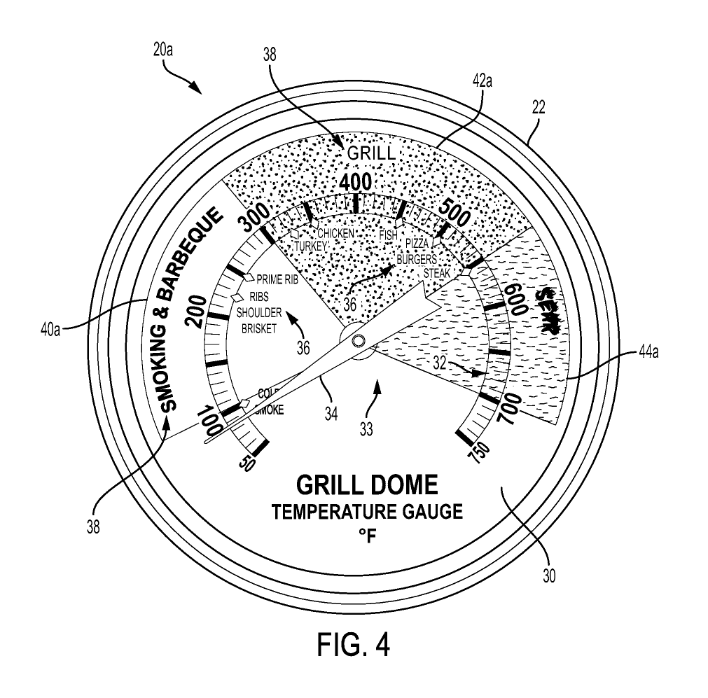

Referring now to FIG. 4, an alternate embodiment of a thermometer 20a in accordance with the present disclosure is shown. Thermometer 20a differs only from the previously discussed embodiment in that each of first, second, and third display portions 40a, 42a, and 44a, are pie-shaped rather than being semi-circular. As shown, each display portion extends from center 33 of display panel 30 radially-outwardly toward the outer perimeter of the display panel. As shown, the represented temperature range of each display portion, for example, 100° to 300°, lies within the corresponding display portion (in this example first display portion 40a).

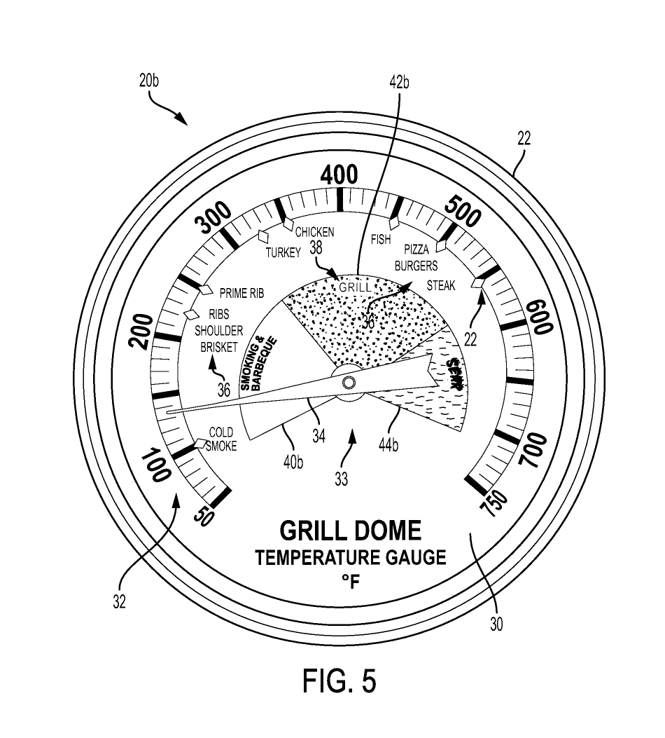

Referring now to FIG. 5, an alternate embodiment of a thermometer 20b in accordance with the present disclosure is shown. Thermometer 20b differs from the previously discussed embodiment shown in FIG. 3 in that each of first, second, and third display portions 40b, 42b, and 44b, are pie-shaped rather than being semi-circular. As shown, each display portion extends from center 33 of display panel 30 radially-outwardly toward the outer perimeter of the display panel. As shown, the represented temperature range of each display portion, for example, 100° to 300°, lies within the corresponding display portion (in this example first display portion 40b).

While one or more preferred embodiments of the invention are described above, it should be appreciated by those skilled in the art that various modifications and variations can be made in the present invention without departing from the scope and spirit thereof. For example, the shape of the body of the thermometer need not be circular, but could be other shapes such as, but not limited to, oval, square, semi-circular, etc. It is intended that the present invention cover such modifications and variations as come within the scope and spirit of the appended claims and their equivalents.

What is claimed is:

1. A thermometer for a grill, comprising:
a body portion comprising:
a display panel disposed on a front side of the body portion,
a graduated temperature scale disposed on the display panel, the temperature scale indicating a range of temperatures from a low temperature to a high temperature,
an indicator needle that is pivotable with respect to the body portion so as to pivotably move relative to the temperature scale, thereby indicating an internal temperature of the grill, and
a first display portion that extends from a first temperature to a second temperature on the temperature scale, thereby defining a first temperature range therebetween, the first display portion being a first color; and
a sensor probe extending outwardly from a back side of the body portion,
wherein the body portion is disposed on an outer surface of the grill and the sensor probe extends into an interior of the grill.

2. The thermometer of claim 1, wherein:
the display panel is circular;
the temperature scale is semi-circular; and
the first display portion is semi-circular in shape.

3. The thermometer of claim 2, wherein the first display portion is disposed between the temperature scale and an outer perimeter of the display panel.

4. The thermometer of claim 2, wherein the display portion is disposed radially-inwardly of the temperature scale.

5. The thermometer of claim 1, wherein:
the display panel is circular;
the temperature scale is semi-circular; and
the first display portion is pie-shaped.

6. The thermometer of claim 5, wherein the first display portion is disposed radially-inwardly of the temperature scale.

7. The thermometer of claim 5, wherein the first display portion extends from a center of the display panel radially-outwardly beyond the temperature scale.

8. The thermometer of claim 2, wherein the first temperature range corresponds to a cooking method, and a word description of the cooking method is disposed within the first display portion.

9. The thermometer of claim 2, further comprising a food-type designator including a marker disposed on a specific temperature of the temperature scale and a word description of a corresponding food item, wherein the specific temperature corresponds to an internal temperature of the grill for preparing the corresponding food item.

10. The thermometer of claim 2, further comprising a second display portion that extends from a third temperature to a fourth temperature on the temperature scale, thereby defining a second temperature range therebetween, the second display portion being a second color that is different than the first color.

11. A thermometer for a grill, comprising:
a body portion comprising:
a display panel disposed on a front side of the body portion,
a graduated temperature scale disposed on the display panel, the temperature scale indicating a range of temperatures from a low temperature to a high temperature,
an indicator needle that is pivotable with respect to the body portion so as to pivotably move relative to the temperature scale, thereby indicating an internal temperature of the grill, and
a food-type designator including a marker disposed on a specific temperature of the temperature scale and a word description of a corresponding food item, wherein the specific temperature corresponds to an internal temperature of the grill for preparing the corresponding food item; and
a sensor probe extending outwardly from a back side of the body portion,
wherein the body portion is disposed on an outer surface of the grill and the sensor probe extends into an interior of the grill.

12. The thermometer of claim 11, the display panel further comprising a first display portion that extends from a first temperature to a second temperature on the temperature scale, thereby defining a first temperature range therebetween, the first display portion being a first color.

13. The thermometer of claim 12, wherein:
the display panel is circular;
the temperature scale is semi-circular; and
the first display portion is semi-circular in shape.

14. The thermometer of claim 13, wherein the first display portion is disposed between the temperature scale and an outer perimeter of the display panel.

15. The thermometer of claim 13, wherein the display portion is disposed radially-inwardly of the temperature scale.

16. The thermometer of claim 11, wherein:
the display panel is circular;
the temperature scale is semi-circular; and
the first display portion is pie-shaped.

17. The thermometer of claim 16, wherein the first display portion is disposed radially-inwardly of the temperature scale.

18. The thermometer of claim 16, wherein the first display portion extends from a center of the display panel radially-outwardly beyond the temperature scale.

19. The thermometer of claim 13, wherein the first temperature range corresponds to a cooking method, and a word description of the cooking method is disposed within the first display portion.

20. The thermometer of claim 13, further comprising a second display portion that extends from a third temperature to a fourth temperature on the temperature scale, thereby defining a second temperature range therebetween, the second display portion being a second color that is different than the first color.
